(19) United States
(12) Patent Application Publication
(10) Pub. No.: US 2004/0122893 A1
(43) Pub. Date: Jun. 24, 2004

(54) Method for transfering web page data to a network services interface, and storage medium therefor

(76) Inventors: Tsung-Wei Tu, Tainan City (TW); Pai-Pin Wang, Shinju County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/406,470

(22) Filed: Apr. 3, 2003

(30) Foreign Application Priority Data
Dec. 20, 2002 (TW) 91136932

(51) Int. Cl. G06F 15/16

(52) U.S. Cl. 709/203

(57) ABSTRACT

A method for transferring web page data to a web services interface. The method combines XML format data files and network technology to provide a data acquisition method for users. The acquired contents of data can be further processed or utilized. The accomplished network services interfaces can be intermixed in a pipeline configuration to satisfy actual query requirements.

### BACKGROUND OF THE INVENTION

1. Field of the Invention

The present invention relates to web page data transfer technology, and in particular to a method for transferring web page data to a web services interface.

2. Description of the Related Art

With the popularization of networks, displaying the contents of data in web pages, for introduction or promotion has become indispensable for most organizations, businesses, and private users. Generally speaking, web page data uses HTML viewable in a web browser, allowing display of varied data.

Because of its complex structure and web page presentation information, HTML data is easy to view in a browser but difficult to acquire for further processing or utilization.

### SUMMARY OF THE INVENTION

Accordingly, an object of the invention is to provide a method for transferring web page data to a web services interface. The method combines XML format files and network services technology to provide a data retrieval method for HTML data files, whereby users can retrieve desired web content for advanced data processing or utilization. Furthermore, the transferred web services interface can be accessed through a network standard protocol, accomplishing the goal of network resource sharing, thereby solving the problem of the present technology.

Another object of the invention is to combine multiple transferred network services interfaces in a pipeline configuration to satisfy actual query requirements. As an example, if an organization desires to collect related web page data for all sub-organizations, the inventive method allows acquisition of desired content arranging it in complete files, which can then be accessed for further data processing or utilization through a network standard protocol.

To achieve the present objects, the invention discloses a method for transferring web page data to a network services interface. First, a web page data file comprising desired data to be transferred is retrieved. The web page data file is normally an HTML data file.

A data acquisition method is then determined according to the desired data to be transferred. The data acquisition method, including HTTP/ACQUIRE, HTTP/ACQUIRE with parameters, and HTTP/POST, acquires the desired data to be transferred.

Next, the determined data acquisition method is executed to acquire the desired data. The acquired data is transferred to a data content file according to XSLT rules. The transfer rules of the web page data file are posted to a transfer rules file. The mapping relationship between the data content file and the transfer rules file is posted to a relational definition file. The data content file, the transfer rules file, and the relational definition file are all XML format and can be edited independently.

For termination, the data content file, the transfer rules file, and the relational definition file are combined to a network services interface. Through a network standard protocol, such as SOAP, users can acquire the relational definition file from the network services interface and refer to the data content file and the transfer rules file to acquire the web page data. In addition, the method can produce several network services interfaces according to the query requirement and combine the produced network services interfaces to acquire the query result.

As well, the invention discloses a storage medium, for storing a computer program. The computer program implements a method for transferring web page data to a network services interface. The method includes the steps mentioned.

### BRIEF DESCRIPTION OF THE DRAWINGS

The present invention can be more fully understood by reading the subsequent detailed description and examples with references made to the accompanying drawings, wherein:

FIG. 1 is a flowchart of the method for transferring web page data to a network services interface;

FIG. 2 is a diagram of a network services interface;

FIG. 3 is a diagram of a parallel query combination; and

FIG. 4 is a diagram of sequential query combination.

### DETAILED DESCRIPTION OF THE INVENTION

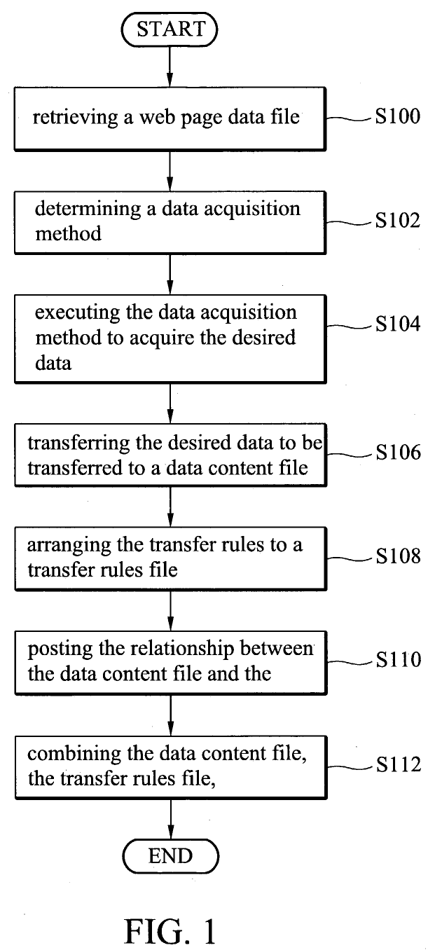

FIG. 1 shows a flowchart of the method of transferring web page data to a network services interface, First, a web page data file is retrieved (step S100). The web page data file is HTML and includes desired data to be transferred. The web page data file of a news website may include web page data and web page presentation information, such as news stories, real-time news tickertape, news navigation, and alternate buttons. If news stories are the desired data to be transferred, the web page data file that includes the news stories is retrieved.

A data acquisition method is then determined according to the desired data to be transferred (step S102). The data acquisition method can be HTTP/ACQUIRE, HTTP/ACQUIRE with parameters, or HTTP/POST.

For explanation, if desired data to be transferred can be acquired directly from a web data file, HTTP/ACQUIRE is selected to retrieve the desired data. If the desired data to be transferred cannot be acquired directly from a web page data file, such as stock information provided by a website, and requires some related parameters, HTTP/ACQUIRE with parameters is selected to retrieve the desired data. As well, if the desired data to be transferred cannot be acquired directly or by related parameters, such as product information provided by a retail website, but requires table transmission, HTTP/POST is selected to retrieve the desired data.

As given above, the method in the step S102 is determined according to the actual desired data and the web page data file that includes the desired data.

Next, the determined data acquisition method is executed to acquire the desired data (step S104). The acquired data is transferred to a data content file according to XSLT rules (step S106). The transfer rules of the web page data file are posted to a transfer rules file (step S108). The mapping relationship between the data content file and the transfer rules file is posted to a relational definition file (step S110). Because the data content file, the transfer rules file, and the relational definition file are all XML format files and can be edited independently, the various data content files, transfer rules files, and relational definition files can be edited to acquire the desired data.

Finally, the data content file, the transfer rules file, and the relational definition file are combined in a network services interface (step S112). The network services interface can be accessed through a program or system after creation. The network services interface may be defined by WSDL rules and accessed by users through a standard network protocol, such as SOAP. Users can acquire the relational definition file and refer to the data content file and the transfer rules file to acquire the desired web page data.

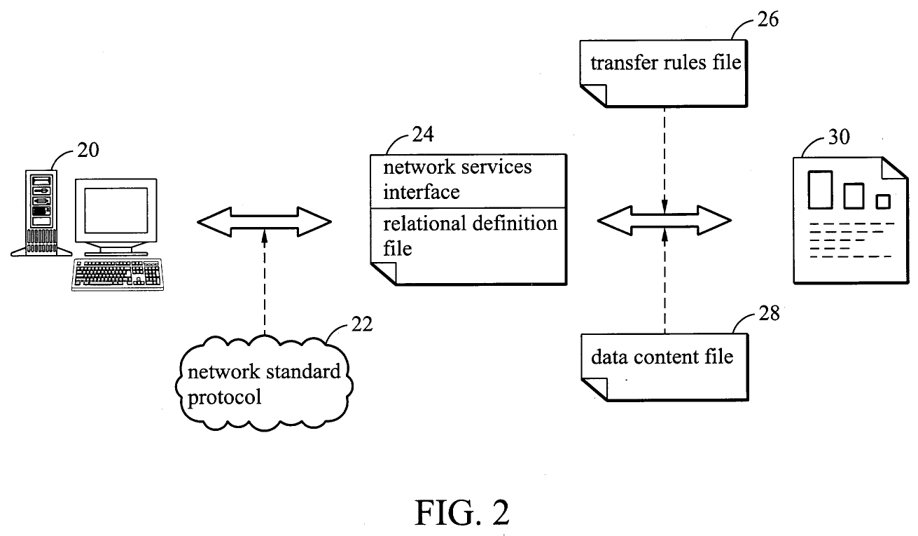

FIG. 2 is a diagram of a network services interface, created by the inventive method, and includes a data content file, a transfer rules file, and a relational definition file. Users can access the web services interface from a program or system 20 through a network standard protocol 22. Users acquire the relational definition file 24 and refer to the transfer rules file 26 and the data content file 28 to acquire an HTML file 30. The transferred network services interface 24 can be accessed by multiple users, that is, the program or system 20 is not appointed to a specific user. Users can acquire desired data from an HTML file and transfer it to a XML format file without writing programs. The acquired data can be further processed or utilized, accomplishing the goal of network resource sharing.

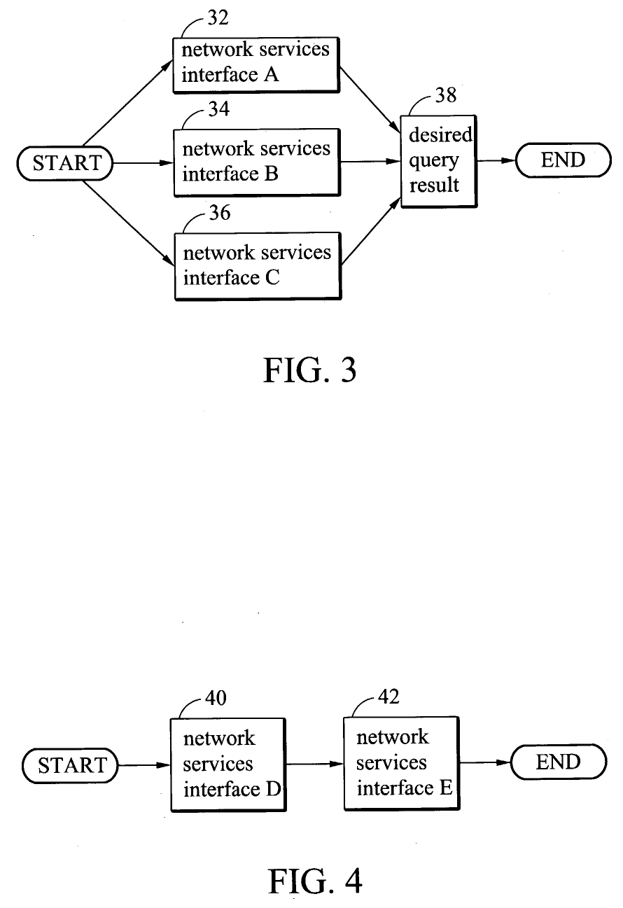

Additionally, users can produce multiple network services interfaces according to an actual query requirement and combine the created network services interfaces to acquire the desired query result. FIG. 3 is a diagram of parallel query combination. In a parallel query there is no sequential order to the constituent queries. If three web data files are needed to acquire a combined query result, three network services interfaces are produced by the inventive method, such as network services interfaces A 32, B 34, and C 36. Each network services interface includes a data content file, a transfer rules file, and a relational definition file. The three files are all XML format and independent. Thus, the produced XML format files can be combined to acquire the desired query result 38.

For example, if an organization wishes to gather related news from three different news websites A, B, and C daily, by the method of the invention, web page data files of the three websites are transferred to network services interfaces A 32, B 34, and C 36 respectively. The produced XML format files are then combined to acquire the desired query result 38.

FIG. 4 is a diagram of sequential query combination. In a sequential query, there is an order to the constituent queries. If two web data files are needed to acquire a query result, the network services interfaces are produced sequentially by the inventive method, that is, network services interface D 40 and network services interface E 42.

If an organization wishes to acquire related news from two different news websites D and E daily, web page data files of website D are transferred to network services interface D 40, and then web page data files of website E are transferred to network services interface E 42, resulting in the desired query result.

Alternatively, if a query requirement is a compound query, the parallel query and sequential query can be intermixed. For instance, if five queries from five different websites are needed to acquire the query result, with three parallel and two sequential, the methods shown in FIG. 3 and FIG. 4 can be applied together to acquire the final query result.

As given above, the combination of queries is determined according to the actual query requirement, presenting the flexibility of a complex query and the satisfaction of a Master-Detail query.

As well, the invention discloses a storage medium, for storing a computer program. The computer program provides the method of data acquisition disclosed previously.

Thus, a method for transferring web page data to a web services interface is provided by the invention. The disclosed method combines XML format files and network services technology to provide a data content retrieval method for transferring Web content to a network services interface. The method adopts XML format as a file format, such that the accomplished network services interface can be accessed by a program or system. In addition, the method applies a pipeline configuration to combine multiple network services interfaces to achieve a compound query, presenting a significant advantage in the field of network resource sharing and complex query requirement.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for transferring web page data to a web services interface, comprising:
retrieving a web page data file, including desired data to be transferred;
determining a data acquisition method according to the desired data to be transferred;
executing the data acquisition method to acquire the desired data;
transferring the desired data to be transferred to a data content file;
arranging the transfer rules to a transfer rules file;
posting the relationship between the data content file and the transfer rules file to a relational definition file; and
combining the data content file, the transfer rules file, and the relational definition file into a network services interface.

2. The method for transferring web page data to a web services interface as claimed in claim 1, further comprising:
acquiring the relational definition file from the network services interface; and
referring to the data content file and the transfer rules file to acquire the web page data file.

3. The method for transferring web page data to a web services interface as claimed in claim 1, further comprising:
producing a plurality of the network services interfaces; and
combining the network services interfaces to acquire a query result.

4. The method for transferring web page data to a web services interface as claimed in claim 1, wherein the web page data file is an HTML file.

5. The method for transferring web page data to a web services interface as claimed in claim 1, wherein the data content file, the transfer rules file, and the relational definition file are independent XML format files.

6. The method for transferring web page data to a web services interface as claimed in claim 1, wherein the transferring step is executed according to XSLT rules.

7. The method for transferring web page data to a web services interface as claimed in claim 1, wherein, in the determining step, the data acquisition method comprises HTTP/ACQUIRE, HTTP/ACQUIRE with parameters, or HTTP/POST.

8. A storage medium storing a computer program providing a method for transferring web page data to a web services interface, the method comprising:
retrieving a web page data file, including desired data to be transferred;
determining a data acquisition method according to the desired data to be transferred;
executing the determined data acquisition method to acquire the desired data;
transferring the desired data to be transferred to a data content file;
arranging the transfer rules to a transfer rules file;
posting the relationship between the data content file and the transfer rules file to a relational definition file; and
combining the data content file, the transfer rules file, and the relational definition file into a network services interface.

9. The storage medium for storing a computer program providing a method for transferring web page data to a web services interface as claimed in claim 6, further comprising:
acquiring the relational definition file from the network services interface; and
referring to the data content file and the transfer rules file to acquire the web page data file.

10. The storage medium for storing a computer program providing a method for transferring web page data to a web services interface as claimed in claim 6, further comprising:
producing a plurality of the network services interfaces; and
combining the network services interfaces to acquire a query result.

11. The storage medium for storing a computer program providing a method for transferring web page data to a web services interface as claimed in claim 6, wherein the web page data file is an HTML file.

12. The storage medium for storing a computer program providing a method for transferring web page data to a web services interface as claimed in claim 6, wherein the data content file, the transfer rules file, and the relational definition file are independent XML format files.

13. The storage medium for storing a computer program providing a method for transferring web page data to a web services interface as claimed in claim 6, wherein the transferring step is executed according to XSLT rules.

14. The storage medium for storing a computer program providing a method for transferring web page data to a web services interface as claimed in claim 6, wherein in the determining step, the data acquisition method comprises HTTP/ACQUIRE, HTTP/ACQUIRE with parameters, or HTTP/POST.
